(19) United States
(12) Patent Application Publication
(10) Pub. No.: US 2008/0167111 A1
(43) Pub. Date: Jul. 10, 2008

(54) GAMING MACHINE ALLOWING A PLAYER TO SELECT A WINNING COMBINATION OF A BASIC GAME

(75) Inventor: Hiro SAKUMA, Tokyo (JP)

Correspondence Address: ARENT FOX LLP, 1050 CONNECTICUT AVENUE, N.W., SUITE 400, WASHINGTON, DC, 20036, US

(73) Assignee: ARUZE CORP., Tokyo (JP)

(21) Appl. No.: 11/971,021

(22) Filed: Jan. 8, 2008

(30) Foreign Application Priority Data
Jan. 10, 2007 (JP) 2007-002454

(51) Int. Cl. A63F 13/00

(52) U.S. Cl. 463/17

(57) ABSTRACT

A gaming machine includes a display device, a memory and a controller. The display device displays an image related to a game. The controller is configured with logic to: (a) cause the display device to display winning combinations so as to provide a player with a chance to select in a basic game; (b) cause the memory to store a winning combination selected by the player; (c) randomly determine symbol data corresponding to the symbols to be displayed on the display device among the symbol data; (d) determine whether the symbols to be displayed on the display device match a winning combination, and simultaneously determine whether the determined winning combination agrees with the winning combination selected by the player; (e) provide a normal award when the winning combination occurs; and (f) provide a service award when the winning combination agrees with the winning combination selected by the player.

This application is based on and claims the benefit of priority from Japanese Patent Application No. 2007-002454, filed on 10 Jan. 2007, the content of which is incorporated herein by reference.

### BACKGROUND OF THE INVENTION

1. Field of the Invention

The present invention relates to a gaming machine having a display for displaying a plurality of symbols and providing an award corresponding to a combination of symbols displayed on the display.

2. Related Art

Conventionally, as a gaming machine, for example, a so-called slot machine in which an award is provided when a symbol is rearranged on an active pay line, an award is provide based on the number of symbols displayed, and a poker game is mainly used, are commonly known.

In addition, many of the gaming machines have the characteristic for changing from a normal game status called a basic game in which a award is provided to a player when a predetermined winning combination is displayed during a game status called, for example, a bonus game such as a free game that increases payout to the player. In addition, U.S. Pat. No. 7,052,392 discloses a technique which improves the winning probability of the bonus game based on a result of the basic game.

### SUMMARY OF THE INVENTION

Although the technique disclosed in U.S. Pat. No. 7,052,392 improves entertainment properties by reflecting the result of the basic game into the bonus game, the award provided to the player when the winning combination is achieved is always the same. In addition, a wager is influenced only if the winning combination is achieved on the active pay line. Thus, the technique disclosed in U.S. Pat. No. 7,052,392 does not sufficiently improve entertainment properties.

The present invention has an object of providing a gaming machine which can further improve entertainment properties.

In an aspect of the present invention, a gaming machine is provided, which includes a display device, a memory and a controller. The display device displays an image related to a game including a basic game and a bonus game. The memory stores symbol data corresponding to a plurality of types of symbols used for the game. The controller is configured with logic to: (a) cause the display device to display winning combinations formed by symbols so as to provide a player with a chance to select in a basic game; (b) cause the memory to store a winning combination selected by the player; (c) randomly determine symbol data corresponding to the symbols to be displayed on the display device among the symbol data stored in the memory; (d) determine whether the symbols to be displayed on the display device match a winning combination, and simultaneously determine whether the determined winning combination agrees with the winning combination selected by the player; (e) provide a normal award when the winning combination occurs; and (f) provide a service award when the winning combination agrees with the winning combination selected by the player.

By providing the abovementioned configuration, two types of games, i.e. the game that executes the normal prize and the game that executes the service award, can be performed concurrently in the basic game. Moreover, a player can be involved in the game that executes the service award by selecting the winning combination.

In another aspect of the present invention, a gaming machine is provided, which includes a display device, a memory and a controller. The display device displays an image related to a game including a basic game and a bonus game. The memory stores symbol data corresponding to a plurality of types of symbols used for the game. The controller is configured with logic to: (a) cause the display device to display winning combinations formed by symbols so as to provide a player with a chance to select in a basic game; (b) cause the memory to store a winning combination selected by the player; (c) randomly determine symbol data corresponding to the symbols to be displayed on the display device among the symbol data stored in the memory; (d) determine whether the symbols to be displayed on the display device match a winning combination, and simultaneously determine whether the determined winning combination agrees with the winning combination selected by the player; (e) provide a normal award when the winning combination occurs; (f) provide a service award when the winning combination agrees with the winning combination selected by the player; and (g) cause the normal award to be higher when the winning combination agrees with the winning combination selected by the player.

By providing the abovementioned configuration, two types of games, i.e. the game that executes the normal award and the game that executes the service award, can be performed concurrently in the basic game. Moreover, a player can be involved in the game that executes the service award by selecting the winning combination. Furthermore, in a case where the winning combination is achieved, the normal award of the winning combination can be increased.

In still another aspect of the present invention, a gaming machine is provided, which includes a display device, a memory and a controller. The display device displays an image related to a game including a basic game and a bonus game. The memory stores symbol data corresponding to a plurality of types of symbols used for the game. The controller is configured with logic to: (a) cause the display device to display winning combinations formed by symbols so as to provide a player with a chance to select in a basic game; (b) cause the memory to store a winning combination selected by the player; (c) randomly determine symbol data corresponding to the symbols to be displayed on the display device among the symbol data stored in the memory; (d) determine whether the symbols to be displayed on the display device match a winning combination, and simultaneously determine whether the determined winning combination agrees with the winning combination selected by the player; (e) provide a normal award when the winning combination occurs; (f) provide a service award when the winning combination agrees with the winning combination selected by the player; (g) cause the normal award to be higher when the winning combination agrees with the winning combination selected by the player; and (h) cause the normal award that has been rendered higher to be lower when the winning combination agrees with a predetermined special winning combination.

By providing the abovementioned configuration, two types of games, i.e. the game that executes the normal award and the game that executes the service award, can be performed concurrently in the basic game. Moreover, a player can be involved in the game that executes the service award by selecting the winning combination. Furthermore, in a case where the winning combination is achieved, the normal award of the winning combination can be increased. Moreover, in a case where the winning combination is achieved, the normal award of the winning combination can be increased. In addition, in a case where a predetermined specified winning combination is achieved, the normal award of the winning combination for which the normal prize that was increased can be lowered.

In yet another aspect of the present invention, a gaming machine is provided, which includes a display device, a memory and a controller. The display device displays an image related to a game including a basic game and a bonus game. The memory stores symbol data corresponding to a plurality of types of symbols used for the game. The controller is configured with logic to: (a) cause the display device to display winning combinations formed by symbols that have a same probability to occur so as to provide a player with a chance to select in a basic game; (b) cause the memory to store a winning combination selected by the player; (c) randomly determine symbol data corresponding to the symbols to be displayed on the display device among the symbol data stored in the memory; (d) determine whether the symbols to be displayed on the display device match a winning combination, and simultaneously determine whether the determined winning combination agrees with the winning combination selected by the player; (e) provide a normal award when the winning combination occurs; and (f) provide a service award when the winning combination agrees with the winning combination selected by the player.

By providing the abovementioned configuration, two types of games, i.e. the game that executes the normal award and the game that executes the service award, can be performed concurrently in the basic game. Moreover, in regards to the game performing the service award, a player can be involved in the game so as to select any one of a plurality of the winning combinations, in which each of the winning probability is equal.

According to the present invention, a player can be involved in a basic game so as to change an award to be provided when a winning combination is achieved. In addition, the present invention can provides a gaming machine which can pluralize a wager in the basic game by way of the player's involvement, thereby further improving entertainment properties.

### BRIEF DESCRIPTION OF THE DRAWINGS

FIG. 1 is a flow chart showing operations according to the present embodiment;

FIG. 2 is a perspective diagram showing a general view of the video slot machine according to the present embodiment;

FIG. 3 is a block diagram showing an electronic configuration of the video slot machine according to the present embodiment;

FIG. 4 is a diagram showing an example of an image displayed on the video slot machine according to the present embodiment;

FIG. 5 shows symbols used for the video slot machine according to the present embodiment;

FIG. 6 shows a symbol arrangement table used for the video slot machine according to the present embodiment;

FIG. 7 shows a random number table used for the video slot machine according to the present embodiment;

FIG. 8 shows a payout table used for the video slot machine according to the present embodiment;

FIGS. 9A to 9C show examples of images displayed on the video slot machine according to the present embodiment;

FIG. 10 shows a service payout table used for the video slot machine according to the present embodiment;

FIG. 11 is a flow chart illustrating a process flow of the video slot machine according to the present embodiment;

FIG. 12 is a flow chart illustrating a process flow of the video slot machine according to the present embodiment;

FIG. 13 shows a payout multiplication table used for the video slot machine according to the present embodiment;

FIG. 14 is a flow chart illustrating a process flow of the video slot machine according to the present embodiment; and

FIG. 15 is a main flow chart illustrating a process flow of the video slot machine according to the present embodiment.

### DETAILED DESCRIPTION OF THE INVENTION

Embodiments of the present invention are described below.

### a. Summary of Embodiments of the Present Invention

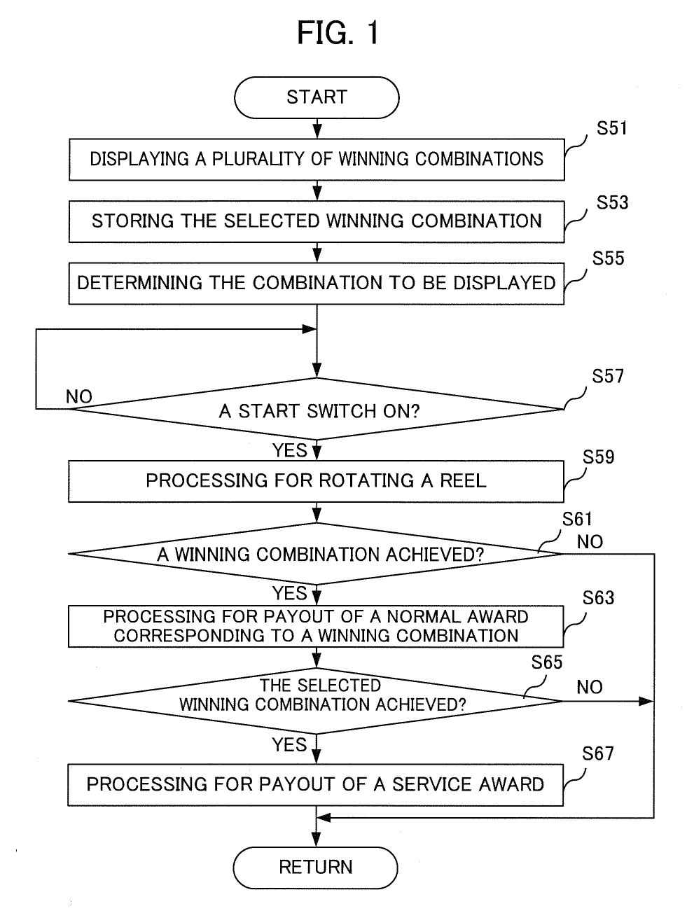

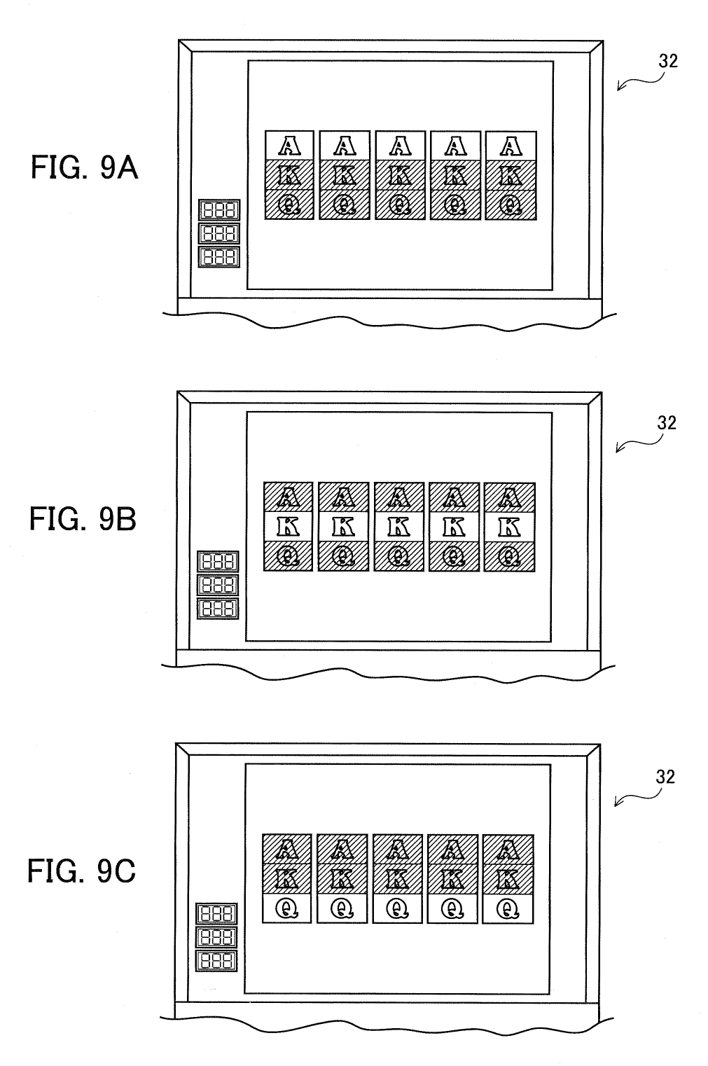

As a detailed description of an embodiment of the one of the gaming machines of the present invention, a so-called video slot machine is exemplified. FIG. 1 shows an example of an operation in a basic game of the video slot machine 10. When the basic game is started, a main control circuit 60 of the video slot 10 displays a plurality of winning combinations on the display 32 (Step S51). More specifically, the main control circuit 60 displays, for example, a winning combination which achieves five “A's” (hereafter, a winning combination A), a winning combination which achieves five “K's” (hereafter, a winning combination K), a winning combination which achieves five “Q's” (hereafter, a winning combination Q), and then displays only the winning combination A brighter (FIG. 9A), thereby rendering the winning combination A selectable. At certain intervals, the main control circuit 60 displays only the winning combination K brighter (FIG. 9B), thereby rendering the winning combination K selectable. Then, at certain intervals, the main control circuit 60 displays only the winning combination Q brighter (FIG. 9C), thereby rendering the winning combination Q selectable. The main control circuit 60 stores a winning combination selected by a player in RAM 70 (Step S53). In addition, the winning probabilities of the winning combinations A, K, and Q are equal.

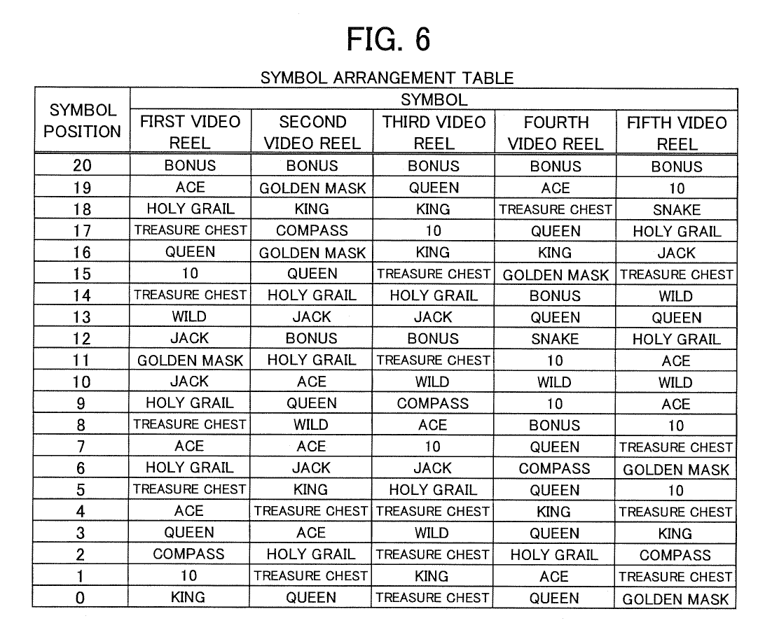

Subsequently, the main control circuit 60 randomly determines a plurality of symbol data to be displayed among the symbol data stored in a memory (FIG. 6) (Step S55). Upon receiving an operational signal of a start switch (Step S57), the main control circuit 60 performs processing for rotating a video reel (Step S59). Then, the main control circuit 60 stops rotating thereof after a certain period of time.

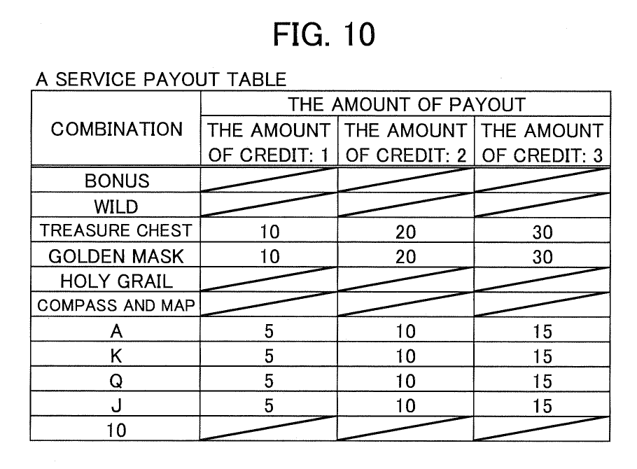

Subsequently, the main control circuit 60 determines whether the displayed combination of symbols is a winning combination or not (Step S61). Then, if so, the main control circuit 60 performs processing for payout of a normal award corresponding to the winning combination (Step S63). Concurrently with this processing, the main control circuit 60 determines whether the displayed combination of symbols is the winning combination selected by the player (Step S65). If so, the main control circuit 60 performs processing for payout of a service award corresponding to the winning combination (FIG. 10) (Step S67). As described above, two types of games are performed concurrently in the basic game.

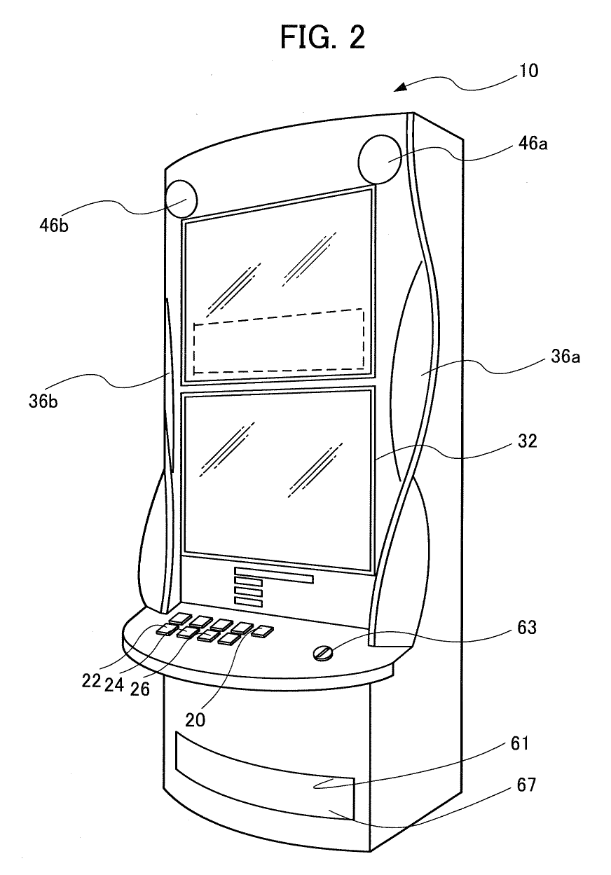

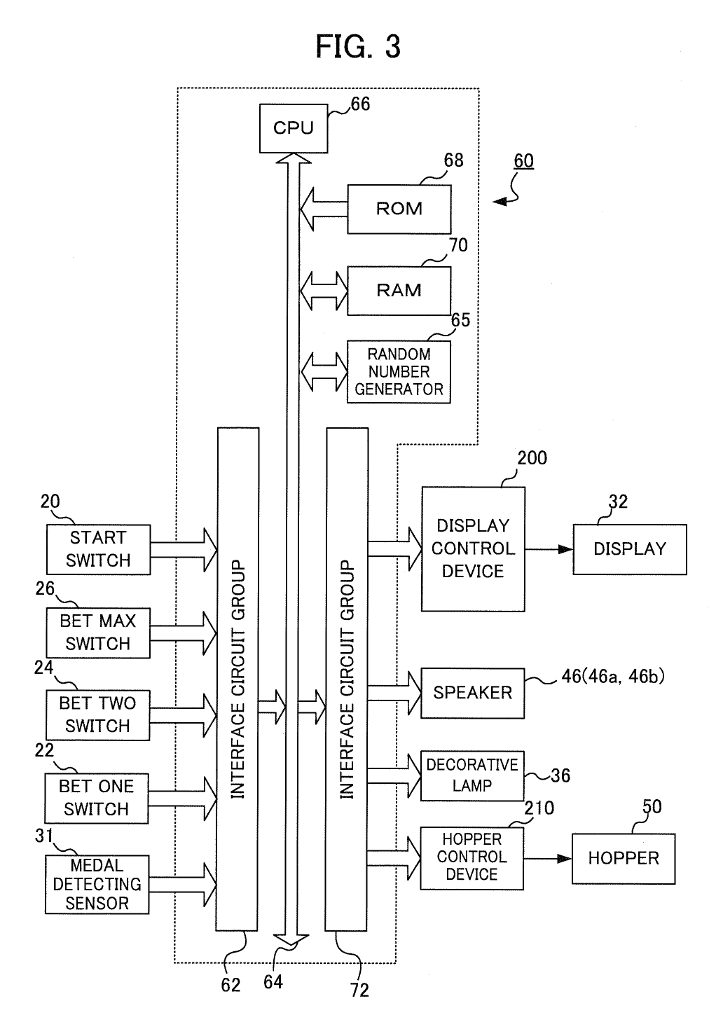

Next, the present embodiment is entirely described, including a configuration of the video slot machine 10. The video slot machine 10 (FIG. 2) is provided with the display 32 for displaying an image for a game, the ROM 68 (FIG. 3) as a memory for storing symbol data (FIG. 6) corresponding to the types of the symbols, the start switch 20 (FIG. 2) for starting the game, and the main control circuit 60 (FIG. 3) as a controller for randomly determining a plurality of symbol data so as to control the game.

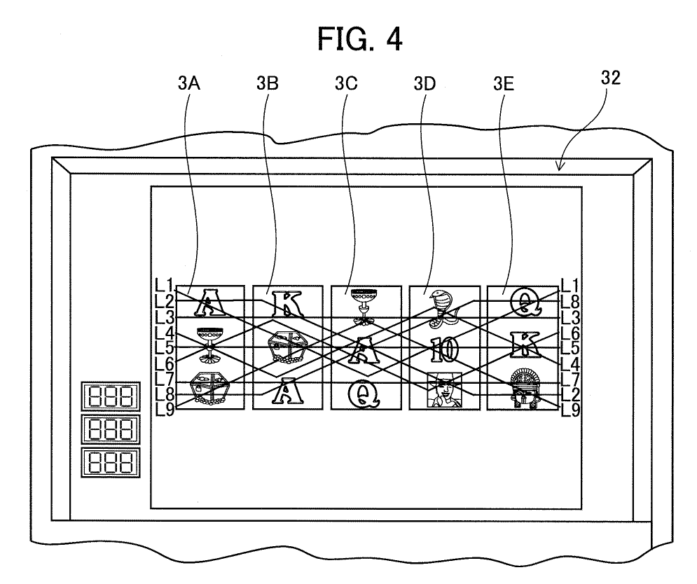

When a basic game is started, the main control circuit 60 displays a plurality of winning combinations (FIG. 9), thereby transitioning to the state in which winning combinations are selectable by a player. “Winning combinations” refers to a plurality of combinations of symbols that provide awards. Then, the main control circuit 60 stores the winning combination selected by the player in the RAM 70. The main control circuit 60 randomly determines a plurality of symbol data to be displayed among the symbol data (FIG. 6) stored in the ROM 68. The main control circuit 60 determines which winning combination is achieved corresponding to a plurality of symbols displayed in the display 32, and simultaneously determines if the winning combination determined to be achieved is the winning combination that was selected by the player and stored in the RAM 70. Then, the main control circuit 60 displays the plurality of symbols that was determined to be displayed (FIG. 4). In cases in which the combination of symbols that were displayed is any of the winning combinations, the main control circuit 60 provides a normal award (for example, a value of payout, medals, and the like) corresponding to the type of the winning combination. In addition, in cases in which the winning combination is the one that was selected by a player and stored in RAM 70, the main control circuit 60 provides a service award (for example, a valuable prize, medals, and the like). Furthermore, in cases in which the winning combination is the one that proceeds to a bonus game, the main control circuit 60 starts the bonus game. More details of the present embodiment are explained with reference to the figures as follows.

### b. Video Slot Machine Configuration

The external appearance of the video slot machine 10, which is the first embodiment of the present invention, is described. FIG. 2 is a perspective diagram showing a general view of the video slot machine 10, which is the first embodiment of the present invention. In this embodiment, a video slot machine using medals as a gaming medium is described as an example; however, a gaming medium for the gaming machine of the present invention may include coins, medals, tokens, cards storing valuable information of games, and the like.

The display 32 for displaying images relating to a game is provided at the front of the video slot machine 10. A plurality of the rearranged symbols is displayed on the display 32 of the video slot machine 10.

In addition, a medal slot 63 is provided in the vicinity of a right side at the front of the video slot machine 10. A medal discharge slot 61 and a medal tray 67 are provided on the lower side at the front of the video slot 10, respectively. A game can be started by a player inserting a medal into the medal slot 63. Then, medals are discharged from the medal discharge slot 61 in response to the gaming result and collected in the medal tray 67. As described later, a medal detecting sensor 31 (see FIG. 3) is embedded inside the video slot machine 10 with which the medal slot 63 is provided. The medal detecting sensor 31 can detect the time a player inserts a medal into the video slot machine 10.

In addition, speakers 46a and 46b are provided on the upper side of the video slot machine 10. The speakers 46a and 46b generate sound effects and the like in accordance with the progress of the game. Decorative lamps 36a and 36b are provided on both right and left sides of the substantially center portion of the video slot machine 10. The decorative lamps 36a and 36b emit light in accordance with the progress of the game.

A start switch 20, a bet max switch 26, a bet two switch 24, and a bet one switch 22, which are used for advancing the game, are disposed on the lower side of the display 32. The bet max switch 26, the bet two switch 24, and the bet one switch 22 are used by a player to start a game.

### c. Control Unit of the Video Slot Machine Configuration

Next, the constitution of the control unit of the video slot machine 10 is described below. FIG. 3 is a block diagram of a control circuit of the video slot machine that is the first embodiment of the present invention.

The main control circuit 60, which is a controller, is configured to be connected to a central processing unit (hereafter, CPU) 66, Read Only Memory (hereafter, ROM) 68, Random Access Memory (hereafter, RAM) 70, a random number generator 65, and interface circuit groups 62 and 72 via an input/output bus 64. The input/output bus 64 inputs and outputs a data signal, a control signal, and an address signal to the CPU 66.

The CPU 66 reads and writes data to each element and device connected to the input/output bus 64 based on a computer program stored in the ROM 68, and processes in cooperation with each element and device. A timer (not shown) is also provided inside the CPU 66.

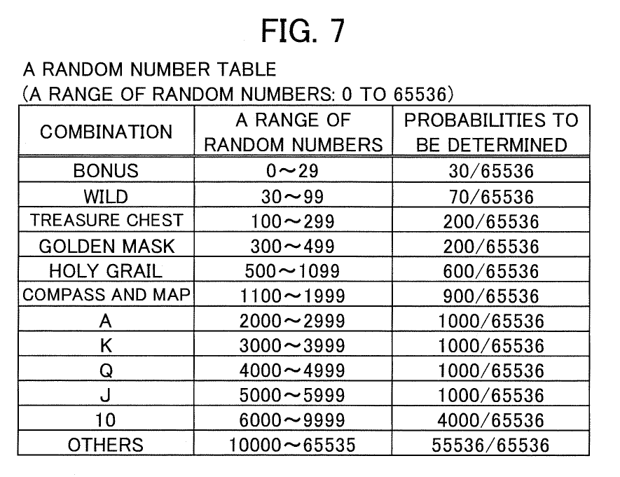

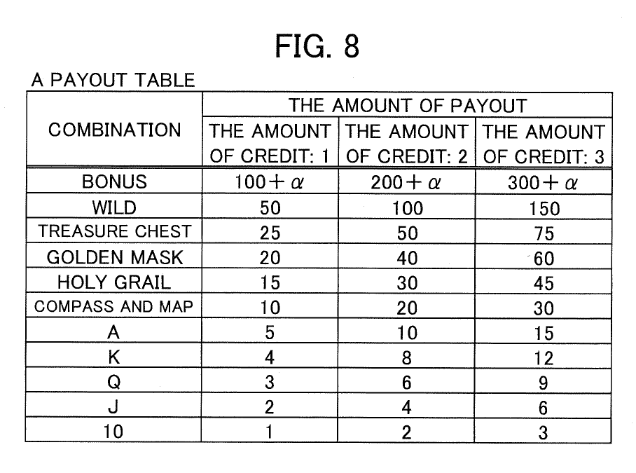

The ROM 68 and the RAM 70 as storing means are also connected to the input/output bus 64. The ROM 68 stores a control program for controlling an entire flow of the game of the video slot machine 10. The ROM 68 also stores initial data for executing a control program, a program for controlling an operational pattern of blinking of the decorative lamp 36 (36a and 36b (see FIG. 2)) embedded in the video slot machine 10, a program for display control on the display 32, and the like. Furthermore, the ROM 68 stores a symbol arrangement table (FIG. 6), a random number table matching symbol data and the probability of symbol data to be randomly determined (FIG. 7), a payout table (FIG. 8), a service payout table (FIG. 9), and the like.

The random number generator 65 for generating a random number is also connected to the input/output bus 64. When an instruction for generating a random number is transmitted to the random number generator 65 from the CPU 66, the random number generator 65 generates a predetermined range of random numbers, and transmits a signal indicating the value of the random number to the input/output bus 64. In the CPU 66, random determinations, which are described below, are done according to the generated random numbers. The random numbers generated from the random number generator 65 are stored in the RAM 70.

In the present embodiment, random numbers are generated by the random number generator 65 connected through the CPU 66 and input/output bus 64. However, the present invention is not limited to this embodiment and may be configured to execute random number generation on an operational program of the CPU 66 as a means for generating random numbers. In this case, the random number generator 65 can be omitted.

The start switch 20, the bet max switch 26, the bet two switch 24, and the bet one switch 22 are connected with the interface circuit group 62. When these switches are activated by a player's pressing operation, each switch transmits a pressing operation detection signal to the interface circuit group 62. The interface circuit group 62 supplies the pressing operation detection signal to the input/output bus 64.

The abovementioned medal detecting sensor 31 is also connected with the interface circuit group 62. A detection signal from the medal detecting sensor 31 is supplied to the input/output bus 64 after converting a certain signal by the interface circuit group 62.

A display control device 200 is also connected with the interface circuit group 72. The display control device 200 transmits a drive signal for driving the display 32 connected with the display control device 200 based on an instruction for displaying images, which are generated from the main control circuit 60.

The speakers 46 (46a and 46b) and the decorative lamps 36 (36a and 36b) are connected with the interface circuit group 72. The interface circuit group 72 controls each of the abovementioned devices by supplying a drive signal, electric power for driving, and the like to each device, in response to the result of processing by the CPU 66.

Furthermore, a hopper control device 210 is also connected with the interface circuit group 72. The hopper control device 210 transmits a drive signal for driving a hopper 50 connected to the hopper control device 210 based on an instruction for paying out medals, which is generated from the main control circuit 60.

### d. Pay Lines

The slot machine 10 has nine pay lines L1 through L9 for providing prizes (pay lines) as shown in FIG. 4. Each of these pay lines L1 through L9 is formed such that it extends so as to pass through one of the symbols for each video reel 3A to 3E when the five video reels have stopped. Upon starting a basic game and a bonus game, at least one of the pay lines L1 through L9 is automatically activated. The pay line which is activated is referred to as an “active pay line”. When a winning combination is achieved on the active pay line, a prize is awarded.

### e. Symbol Line

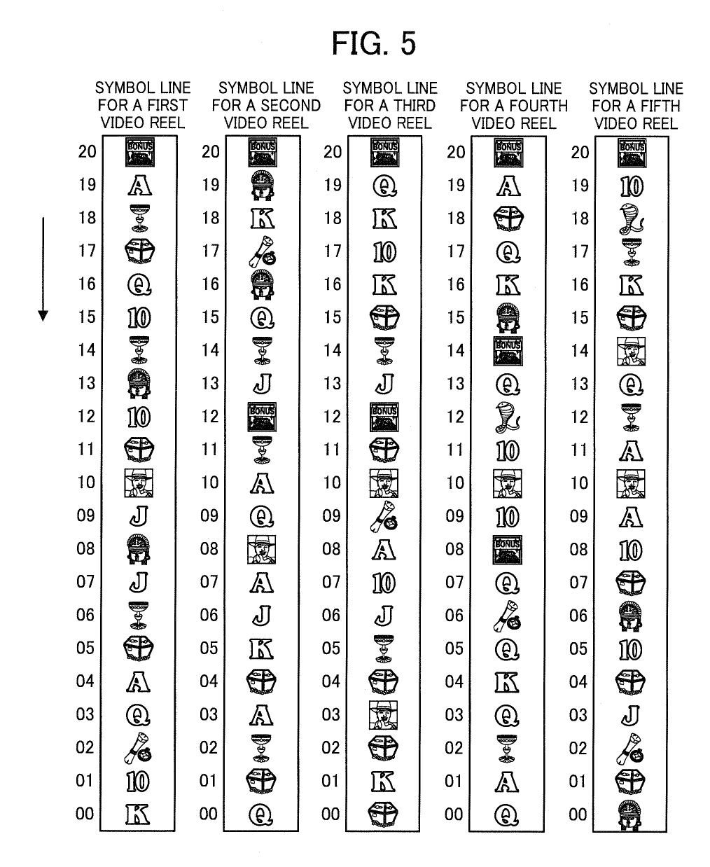

FIG. 5 shows symbol lines on which 21 symbols arranged on each video reel 3A to 3E are represented. Code numbers of “00” to “20” refer to each symbol of the video reels 3A to 3E. These code numbers are converted according to FIG. 6 to be data in a symbol data table so as to be stored in the aforementioned ROM 68 (FIG. 3). On each video reel 3A to 3E, a symbol line is represented with symbols as follows: “Bonus” trigger symbol (hereafter, “Bonus”), “Wild” symbol (hereafter, “Wild”), “Treasure Chest” symbol (hereafter, “treasure chest”), “Golden Mask” symbol (hereafter, “Golden Mask”), “Holy Grail” symbol (hereafter, “Holy Grail”), “Compass and Map” symbol (hereafter, “Compasses and Map”), “Snake” symbol (hereafter, “Snake”), “Ace” symbol (hereafter, “Ace”), “King” symbol (hereafter, “King”), “Queen” symbol (hereafter, “Queen”), “Jack” symbol (hereafter, “Jack”), and “10” symbol (hereafter, “10”). The symbol line of each video reel 3A to 3E moves in the direction of the arrow in FIG. 5 (moving in a top to bottom direction) by rotating each video reel 3A to 3E in a forward direction.

Here in the present embodiment, each combination of “Bonus”, “Wild”, “Snake”, “Treasure Chest”, “Golden Mask”, “Holy Grail”, “Compass and Map”, “Ace”, “King”, “Queen”, “Jack” and “10” is set as a winning combination. A winning combination of “Bonus” indicates that five “Bonus” are achieved on an active line. The same is true of a winning combination such as “Wild”.

In addition, executable games in the present embodiment includes a basic game in which symbols are achieved along the active pay line and a bonus game having a game configuration different from the basic game. In the basic game, two types of games, a game in which a winning combination may be achieved or not and a game in which winning combination is achieved, are performed concurrently.

### f. Random Number Table

FIG. 7 shows a random number table which matches symbol data and the probability of symbol data to be determined. “Symbol data” refers to symbol data which correspond to a plurality of types of symbols used in the game. “Probability” is a ratio of case of symbol data being randomly determined. In addition, the phrase “symbol data being randomly determined” is used in the same sense as the phrase “randomly determining a winning combination” in the present specification. In the random number table, a range of random numbers and the probability of winning are registered in relation to each of winning combinations.

### g. Payout Table

FIG. 8 shows a payout table that matches a winning combination and the amount of payout. In the payout table for the basic game, the coin amount to be paid out is registered in relation to each winning combination for providing a prize for each credit amount bet on one game. Therefore, in cases in which a determination is made that the combination thus generated matches any one of the winning combinations for providing a prize, for example, when the a combination thus generated matches the combination “Wild”, where the credit amount bet is “1”, 50 coins are paid out. In cases where the credit amount bet is “2”, 100 coins are paid out. In cases where the credit amount bet is “3”, 150 coins are paid out. In the basic game, the abovementioned payout performed when a winning combination is achieved is called “a normal prize”.

### h. Service Payout Table

FIG. 10 shows a service payout table which relates a winning combination and the amount of payout. In the service payout table for the basic game, the coin amount to be paid out is registered in relation to each credit amount bet on one game when a winning combination displayed on the display 32 was selected by a player. For example, in cases in which “Treasure Chest” was selected, where the credit amount bet is “1”, 10 coins are paid out. In cases where the credit amount bet is “2”, 20 coins are paid out. In cases where the credit amount bet is “3”, 30 coins are paid out. In the basic game, the abovementioned payout executed when the selected winning combination is achieved is called “a service award”.

### i. Operation of a Video Slot Machine

Processing to be performed in the main control circuit 60 described above is explained. FIG. 10 is a flow chart of a main processing to be performed in the main control circuit 60 of one embodiment of the present invention.

First, the main control circuit 60 determines whether any credits (coins inserted by the player) are remaining (Step S11). More specifically, the main control circuit 60 reads the amount of credits C stored in the RAM 70 and executes processing based on the amount of credits C. When the amount of credits C is “0” (NO determination in the processing of Step S11), since the main control circuit 60 cannot start a game, the processing of Step S11 is repeated until a YES determination results. When the number of credits C is not less than “1” (YES in Step S11), the main control circuit 60 determines that coins remain as credits, and the main control circuit 60 moves the processing to Step S13.

Upon moving to Step S13, the main control circuit 60 determines whether any one of the bet switches 22, 24, and 26 has been pressed (Step S13). When the bet switch 22, etc. has been pressed, and then an operational signal from the bet switch 22, etc. is input (YES determination in the processing of Step S13), the main control circuit 60 moves the processing to Step S15. On the other hand, when the operational signal from the bet switch 24 has not been input after a predetermined amount of time has elapsed (NO in Step S13), the main control circuit 60 determines that the bet switch 22, etc. has not been pressed and moves the processing to Step S13 again.

In the following Step S15, the main control circuit 60 sets the game conditions. More specifically, the main control circuit 60 determines an active pay line, and then determines the amount of coins to be bet to the active pay line of the present game based on the operation of the bet switch 22, etc. Then, the main control circuit 60 determines the bet amount to be bet on the active pay lines based upon the number of times signals that indicate operation of the bet switch 22, etc. have been received, and stores the bet amount regarding the pay line to be activated in a predetermined memory area of the RAM 70. The main control circuit 60 reads the amount of credits C stored in a predetermined memory area of the RAM 70, and subtracts the total bet amount, which is the sum of the aforementioned bet amounts, from the amount of credits C thus read. Then, the main control circuit 60 stores the subtracted value in a predetermined memory area of the RAM 70. Then, the main control circuit 60 moves the processing to Step S17, and a basic game is started.

Upon starting a basic game, the main control circuit 60 reads winning combinations from the RAM 70 (FIG. 7) and displays a plurality of winning combinations on the display 32, thereby rendering it selectable to a player (Step S51). More specifically, the state of displaying a winning combination A brighter (FIG. 9A), the state of displaying a winning combination K brighter (FIG. 9B), and the state of displaying a winning combination Q brighter (FIG. 9C) are repeated at certain intervals. Then, a player, for example, presses the start switch 20, thereby rendering the winning combinations displayed brighter selectable to the player. In this case, the start switch serves a function as a switch for selecting a winning combination. The main control circuit 60 stores a winning combination selected by a player in the RAM 70 (Step S53).

Subsequently, the main control circuit 60 randomly determines a plurality of symbol data to be displayed among the symbol data (FIG. 6) stored in the ROM 68 (Step S55). Then, it is determined whether the start switch has been activated (Step S57). Upon the start switch 25 being operated, and accordingly upon the operational signal being input from a start switch 25 (YES determination in processing of Step S57), the main control circuit 60 determines that the start switch 25 has been operated, and advances processing to Step S59. If the processing of Step S57 is a NO determination, the main control circuit 60 repeats the processing of Step S57 until YES determination results.

Upon receiving an operational signal of a start switch (Step S57), the main control circuit 60 performs processing for rotating a video reel (Step S59). Then, the main control circuit 60 stops rotation thereof after a certain period of time. In cases in which the operational signal of the start switch has not been received in Step S57, the processing of Step S57 is repeated.

Subsequently, the main control circuit 60 determines whether the displayed combination of symbols is a winning combination (Step S61). Then, if so, the main control circuit 60 performs processing for payout of a normal award corresponding to the winning combination (Step S63). If the symbol combination displayed on the display is not any one of the winning combinations, the processing terminates.

Concurrently with the abovementioned processing of the normal award, the main control circuit 60 reads the winning combination selected by the player from the RAM 70 and determines whether the displayed combination of symbols is the winning combination selected by the player (Step S65). If so, the main control circuit 60 reads a service payout table, (FIG. 10) and performs processing for payout of a service award corresponding to the winning combination (FIG. 10) (Step S67). Then, the main control circuit 60 moves the processing to Step S19. On the other hand, if it is not the winning combination selected by the player, the main control circuit 60 moves the processing to Step S19.

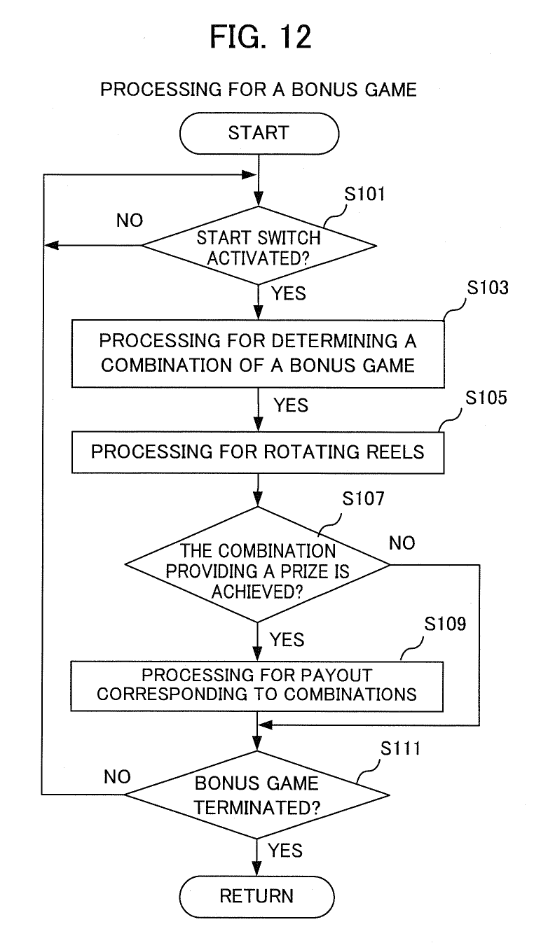

In Step S19, the main control circuit 60 determines whether a bonus combination for a bonus award was achieved. If the main control circuit 60 determines that a bonus combination has been achieved, the main control circuit 60 advances the processing to Step S21. If not, the main control circuit 60 advances the processing to Step S23. FIG. 12 shows detailed descriptions of Step S23.

Upon advancing the processing to Step S23, the main control circuit 60 determines whether a start switch is activated (Step S101 of FIG. 12). Upon the start switch 25 being operated, and accordingly upon the operational signal being input from the start switch 25 (in a case of “YES” in the determination processing in Step S101), the main control circuit 60 determines that the start switch 25 has been operated, and advances the processing to Step S103. If it is a NO determination, the main control circuit 60 repeats the processing of Step S101 until a YES determination results.

In Step S103, the main control circuit 60 performs processing for determining the combination of a bonus game. A specific description is provided below regarding processing for determining the combination of a bonus game.

Firstly, in processing for determining the combination of a bonus game, the main control circuit 60 determines a combination of symbols when they are stationary along the abovementioned active pay line. Specifically, the main control circuit 60 issues a command for the random number generator 65 to generate a random number, thereby extracting a random number in a predetermined range (in a range of “0” to “65535” in the present embodiment) generated by the random number generator 65. The main control circuit 60 stores the random number thus extracted in a predetermined memory area of the RAM 70. The main control circuit 60 reads a random number table (see FIG. 7) stored by the ROM 68, and stores the random number table thus read in a predetermined memory area of the RAM 70. In addition, the abovementioned random number table is provided to each real. Furthermore, the main control circuit 60 reads the abovementioned random number table for a basic game stored in a predetermined memory area of the RAM 70. Then, the main control circuit 60 determines the combination of the symbols when they are stationary with respect to the active pay lines with reference to the abovementioned random number table, using the random number stored in the predetermined memory region of the abovementioned RAM 70 as a parameter. Upon determination of the combination, the main control circuit 60 stores the combination data thus determined in a predetermined memory area of the RAM 70.

Subsequently, in Step S105, the main control circuit 60 starts rotation of the video reels 3A to 3E. Specifically, the main control circuit 60 rotates the video reels 3A to 3E in sequence or simultaneously based upon the symbol arrangement table stored in the aforementioned RAM 110, and stops them after a predetermined amount of time elapses.

Subsequently, in Step S105, the main control circuit 60 determines whether a combination for a bonus award on the active pay line has been achieved. When the combination for a bonus award has not been achieved, the main control circuit 60 advances the processing to Step S111. When the combination for a bonus award has not been achieved, the main control circuit 60 advances the processing to Step S109, and performs processing for a payout corresponding to the combination (Step S109).

Subsequently, the main control circuit 60 determines whether the bonus game has been terminated (Step S111). If not, the main control circuit 60 advances the processing to Step S101. If so, the main control circuit 60 moves the processing to return. When, for example, the predetermined number of bonus games have been carried out, the main control circuit 60 terminates the processing.

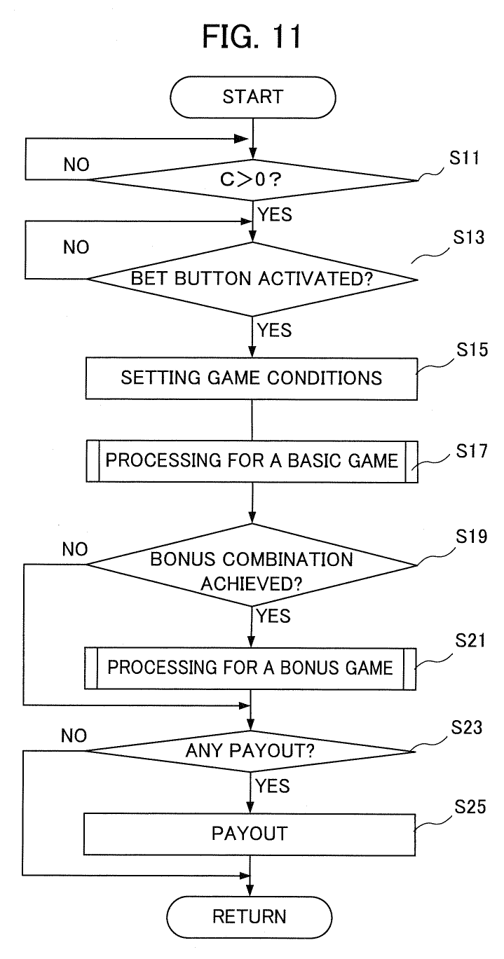

Subsequently, in Step S23 (FIG. 11), the main control circuit 60 determines whether processing for payout should be performed. If not, the main control circuit 60 terminates the processing. If so, the main control circuit 60 performs processing for payout, and then terminates the processing (Step S25).

According to the present embodiment, the following operations and effects are made.

According to the video slot machine 10 described in the present embodiment, two types of games, a game that executes the normal prize and the game that executes the service award, can be performed concurrently in the basic game. Moreover, a player can be involved in the game that executes the service award by selecting the winning combination. Furthermore, in the case where the winning combination is achieved, the normal award of the winning combination can be increased.

### j. Example of a First Variation

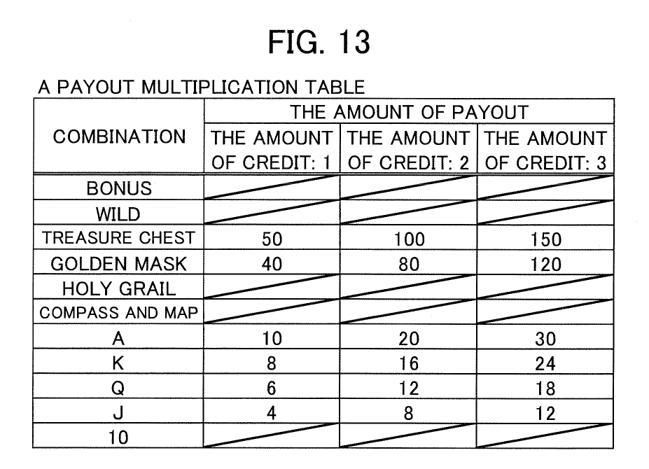

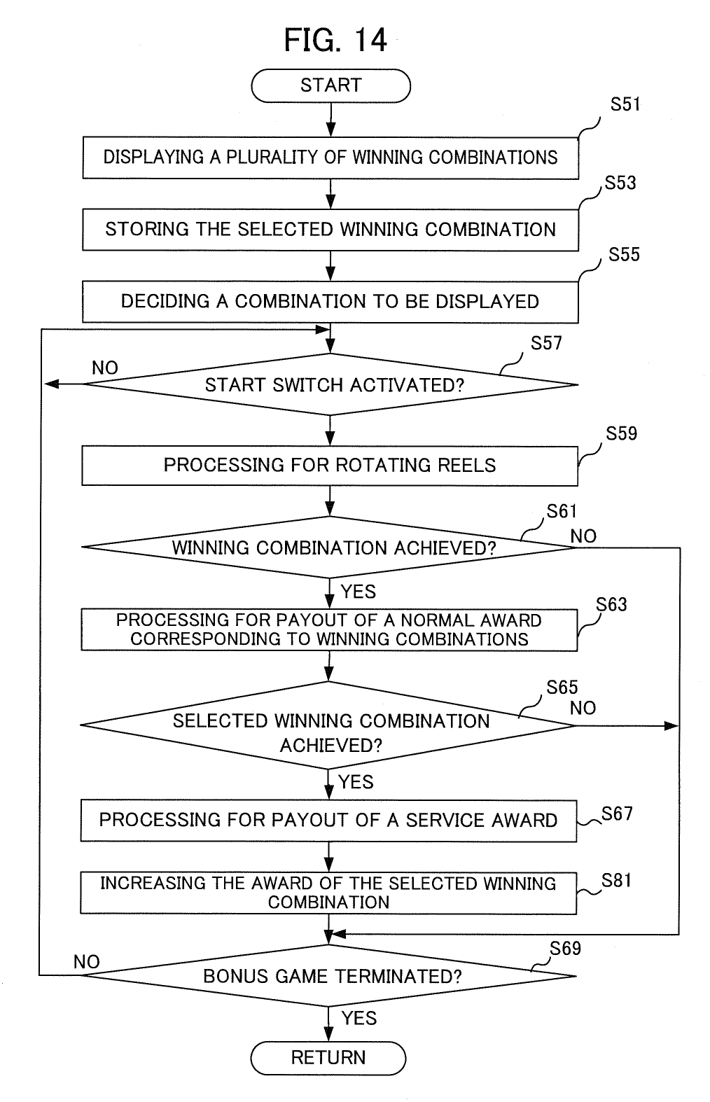

Next, an example of a first variation of the abovementioned embodiment is described below. The video slot machine 10 according to the example of the first variation stores a payout multiplication table (FIG. 13) in the ROM 68 (FIG. 3). An exemplary operation of the video slot machine 10 of the example of the first variation is described with reference to FIG. 14, and is described mainly through differences with the abovementioned embodiment.

FIG. 14 is a flow chart illustrating processing in the basic game. Upon terminating Step S67 in a basic game, the main control circuit 60 increases the normal award of the winning combination selected by a player (Step S81). Specifically, in cases in which the winning combination selected by the player is achieved, regarding this winning combination, in the subsequent basic game, not the payout table (FIG. 8) but the payout multiplication table (FIG. 13) is applied. For example, in cases in which a winning combination A is selected, and then the winning combination A is achieved, the payout multiplication table (FIG. 13) is applied to the subsequent basic game. Then, if the bet amount is 1, 10 coins are paid out. In cases of another winning combination such as a winning combination K, the payout table (FIG. 8) is applied. Then, if the bet amount is 1, 4 coins are paid out.

Furthermore, according to the example of the first transformation, in the case where the winning combination is achieved, the normal award of the winning combination can be increased.

### k. Example of a Second Variation

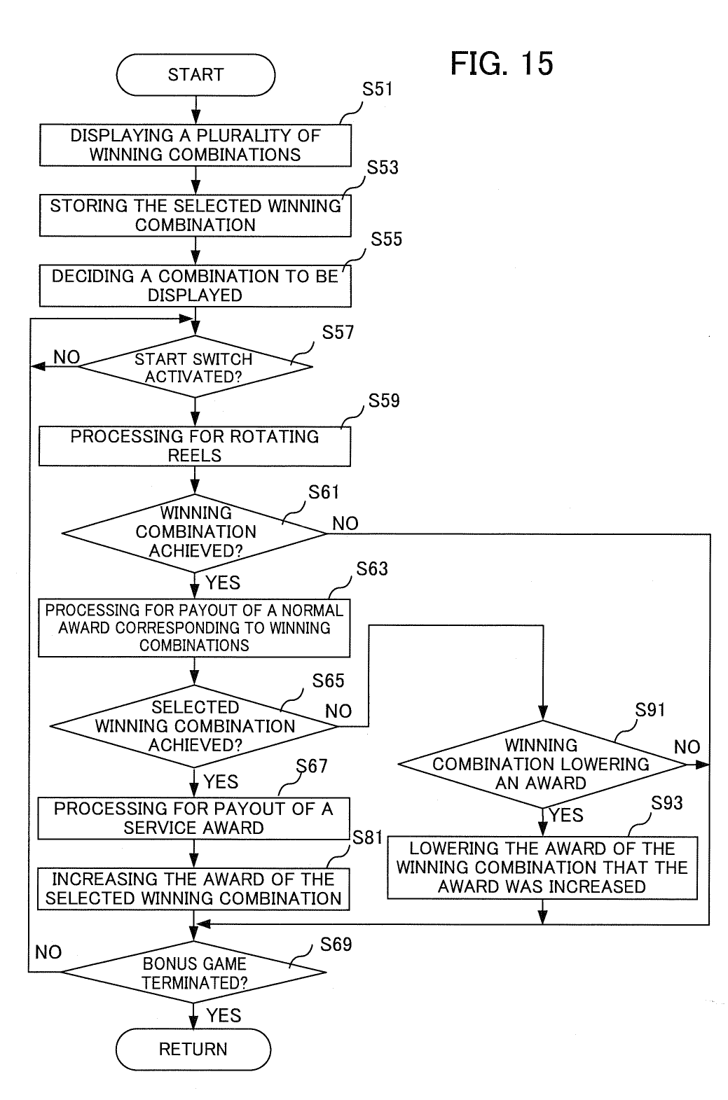

Next, an example of a second variation of the abovementioned embodiment is described below. The configuration of the video slot machine 10 of the example according to the second variation is similar to the abovementioned example of the first variation, but the operation thereof is different. An exemplary operation of the video slot machine 10 of the example of the second variation is described with reference to FIG. 15, and is described mainly through differences with the abovementioned example of the first variation.

FIG. 15 is a flow chart illustrating processing in the basic game. The main control circuit 60 determines whether the achieved winning combination is the one which was selected by the player and stored in the RAM 70 (Step S65). If the main control circuit 60 determines that the winning combination is not the one that was stored in RAM 70, the main control circuit 60 determines whether the achieved winning combination is one that lowers an award (Step S91). A winning combination that lowers an award is the predetermined specified winning combination in order to lower an award for which the winning combination that the award was increased in Step S81 (for example, a winning combination achieving “Wild”).

If the main control circuit 60 determines that it is the winning combination that lowers an award, the main control circuit 60 lowers the award of the winning combination for which the award was increased (Step S93). More specifically, the definition of the award of the winning combination for which the award was increased is changed from the payout multiplication table (FIG. 13) to the payout table (FIG. 8). In addition, in contrast to the abovementioned example, when the main control circuit 60 determines that it is the winning combination that lowers an award, the award may be lowered gradually, such as decreasing the number of coins by two, which is defined by the payout multiplication table (FIG. 13), and not changing to the payout table (FIG. 8).

As described above, according to the example of the second embodiment, in cases in which the winning combination is achieved, a normal award of the winning combination can be increased. Moreover, in cases in which the predetermined specified winning combination is achieved, the normal award of the winning combination for which the normal award was increased, can be lowered.

Although the embodiments are explained in the above descriptions, the present invention is not limited to those, and various changes and modifications of design can be made within the scope of the claims.

What is claimed is:

1. A gaming machine, comprising:
a display device that displays an image related to a game including a basic game and a bonus game;
a memory that stores symbol data corresponding to a plurality of types of symbols used for the game; and
a controller configured with logic to:
(a) cause the display device to display winning combinations formed by symbols so as to provide a player with a chance to select in a basic game;
(b) cause the memory to store a winning combination selected by the player;
(c) randomly determine symbol data corresponding to the symbols to be displayed on the display device among the symbol data stored in the memory;
(d) determine whether the symbols to be displayed on the display device match a winning combination, and simultaneously determine whether the determined winning combination agrees with the winning combination selected by the player;
(e) provide a normal award when the winning combination occurs; and
(f) provide a service award when the winning combination agrees with the winning combination selected by the player.

2. A gaming machine, comprising:
a display device that displays an image related to a game including a basic game and a bonus game;
a memory that stores symbol data corresponding to a plurality of types of symbols used for the game; and
a controller configured with logic to:
(a) cause the display device to display winning combinations formed by symbols so as to provide a player with a chance to select in a basic game;
(b) cause the memory to store a winning combination selected by the player;
(c) randomly determine symbol data corresponding to the symbols to be displayed on the display device among the symbol data stored in the memory;
(d) determine whether the symbols to be displayed on the display device match a winning combination, and simultaneously determine whether the determined winning combination agrees with the winning combination selected by the player;
(e) provide a normal award when the winning combination occurs;
(f) provide a service award when the winning combination agrees with the winning combination selected by the player; and
(g) cause the normal award to be higher when the winning combination agrees with the winning combination selected by the player.

3. A gaming machine, comprising:
a display device that displays an image related to a game including a basic game and a bonus game;
a memory that stores symbol data corresponding to a plurality of types of symbols used for the game; and
a controller configured with logic to:
(a) cause the display device to display winning combinations formed by symbols so as to provide a player with a chance to select in a basic game;
(b) cause the memory to store a winning combination selected by the player;
(c) randomly determine symbol data corresponding to the symbols to be displayed on the display device among the symbol data stored in the memory;
(d) determine whether the symbols to be displayed on the display device match a winning combination, and simultaneously determine whether the determined winning combination agrees with the winning combination selected by the player;
(e) provide a normal award when the winning combination occurs;
(f) provide a service award when the winning combination agrees with the winning combination selected by the player;
(g) cause the normal award to be higher when the winning combination agrees with the winning combination selected by the player; and
(h) cause the normal award that has been rendered higher to be lower when the winning combination agrees with a predetermined special winning combination.

4. A gaming machine, comprising:
a display device that displays an image related to a game including a basic game and a bonus game;
a memory that stores symbol data corresponding to a plurality of types of symbols used for the game; and
a controller configured with logic to:
(a) cause the display device to display winning combinations formed by symbols that have a same probability to occur so as to provide a player with a chance to select in a basic game;
(b) cause the memory to store a winning combination selected by the player;
(c) randomly determine symbol data corresponding to the symbols to be displayed on the display device among the symbol data stored in the memory;
(d) determine whether the symbols to be displayed on the display device match a winning combination, and simultaneously determine whether the determined winning combination agrees with the winning combination selected by the player;
(e) provide a normal award when the winning combination occurs; and
(f) provide a service award when the winning combination agrees with the winning combination selected by the player.
